(19) United States
(12) Patent Application Publication
(10) Pub. No.: US 2026/0370332 A1
(43) Pub. Date: Nov. 19, 2026

(54) FREE-SPACE OPTICAL COMMUNICATION SYSTEM SUPPORTING MULTIPOINT ACCESS

(71) Applicant: Raytheon Company, Arlington, VA (US)

(72) Inventors: Jae H. Kyung, Palo Alto, CA (US); Andrew M. Kowalevicz, Ashburn, VA (US)

(21) Appl. No.: 19/209,478

(22) Filed: May 15, 2025

(51) Int. Cl. H04B 10/25; H04J 3/16; H04J 14/08

(52) U.S. Cl. CPC H04B 10/25891; H04J 3/1694; H04J 14/08

(57) ABSTRACT

A hub for an optical system includes a dynamic optical switch and a master controller. The dynamic optical switch includes an optical transmitter, an optical receiver, and a beam director. The optical transmitter is configured to transmit outgoing optical signals to a plurality of optical terminals. The optical receiver is configured to receive incoming optical signals from the plurality of optical terminals. The beam director is configured to position the dynamic optical switch at a plurality of angles. The master controller is configured to provide multipoint access for the optical system by implementing a time division multiple access architecture for the optical system.

### TECHNICAL FIELD

This disclosure is generally directed to optical systems. More specifically, this disclosure is directed to a free-space optical communication system supporting multipoint access.

### BACKGROUND

A free-space optical communication (FSOC) system is generally a point-to-point communications link between two optical terminals that can transmit light to and/or receive light from each other through free space rather than through fiber optic cables or other physical cables. By using high directivity and narrow beams, an FSOC system can provide low power, high bandwidth communication. However, these benefits of optical communication are limited when servicing multiple user nodes because each connection to a user node requires its own dedicated, costly FSOC optical terminal with relatively high size, weight, and power requirements.

### SUMMARY

This disclosure relates to a free-space optical communication system supporting multipoint access.

In a first embodiment, a hub for an optical system may include a dynamic optical switch and a master controller. The dynamic optical switch may include an optical transmitter, an optical receiver, and a beam director. The optical transmitter may be configured to transmit outgoing optical signals to a plurality of optical terminals. The optical receiver may be configured to receive incoming optical signals from the plurality of optical terminals. The beam director may be configured to position the dynamic optical switch at a plurality of angles. The master controller may be configured to provide multipoint access for the optical system by implementing a time division multiple access (TDMA) architecture for the optical system.

Any single one or any combination of the following features may be used with the first embodiment. To implement the TDMA architecture for the optical system, the master controller may be configured to assign each of a plurality of time slots to a specified one of the plurality of optical terminals. For each of the plurality of time slots, the master controller may be configured to direct the dynamic optical switch to establish a communication channel with the specified one of the plurality of optical terminals to which the time slot was assigned. The master controller may also be configured to monitor and track locations for each of the plurality of optical terminals for use in establishing the communication channel with the specified one of the plurality of optical terminals. The master controller may also be configured to generate the outgoing optical signals and to process the incoming optical signals. The specified one of the plurality of optical terminals may include at least one modulating retroreflector. The incoming optical signals may include encoded optical signals reflected by the at least one modulating retroreflector. The specified one of the plurality of optical terminals may include a second dynamic optical switch and a second master controller. The second dynamic optical switch may include a second optical transmitter and a second optical receiver. The second optical receiver may be configured to receive the outgoing optical signals. The second master controller may be configured to process the outgoing optical signals and to generate the incoming optical signals. The second optical transmitter may be configured to transmit the incoming optical signals toward the optical receiver. To implement the TDMA architecture for the optical system, the master controller may be configured, for each of a plurality of time slots, to prompt the beam director to position the dynamic optical switch at a specified angle corresponding to a specified one of the plurality of optical terminals, provide a specific data package for the specified one of the plurality of optical terminals to the optical transmitter, and receive data from the optical receiver based on the incoming optical signals received from the specified one of the plurality of optical terminals. The beam director may include a mechanical gimbal, an electronic beam steering mechanism, or a semi-mechanical beam steering mechanism. The dynamic optical switch may also include at least one fast-steering mirror. The beam director may be configured to position the dynamic optical switch at the plurality of angles by changing a position of the at least one fast-steering mirror.

In a second embodiment, an optical system may include a hub and a plurality of optical terminals. The hub may include a dynamic optical switch and a master controller. The dynamic optical switch may include an optical transmitter, an optical receiver, and a beam director. The optical transmitter may be configured to transmit outgoing optical signals to the plurality of optical terminals. The optical receiver may be configured to receive incoming optical signals from the plurality of optical terminals. The beam director may be configured to position the dynamic optical switch at a plurality of angles. The master controller may be configured to provide multipoint access for the optical system by implementing a TDMA architecture for the optical system. Each of the plurality of optical terminals may be configured to receive the outgoing optical signals, generate the incoming optical signals, and provide the incoming optical signals to the hub.

Any single one or any combination of the following features may be used with the second embodiment. Each of the plurality of optical terminals may include at least one modulating retroreflector configured to receive the outgoing optical signals, generate the incoming optical signals by encoding data onto the outgoing optical signals, and provide the incoming optical signals to the hub by reflecting the incoming optical signals toward the optical receiver. Each of the plurality of optical terminals may include a second dynamic optical switch and a second master controller. The second dynamic optical switch may include a second optical transmitter and a second optical receiver. The second optical receiver may be configured to receive the outgoing optical signals. The second master controller may be configured to process the outgoing optical signals and to generate the incoming optical signals. The second optical transmitter may be configured to provide the incoming optical signals to the hub by transmitting the incoming optical signals toward the optical receiver. To implement the TDMA architecture for the optical system, the master controller may be configured to assign each of a plurality of time slots to a specified one of the plurality of optical terminals. For each of the plurality of time slots, the master controller may be configured to direct the dynamic optical switch to establish a communication channel with the specified one of the plurality of optical terminals to which the time slot was assigned. The master controller may also be configured to monitor and track locations for each of the plurality of optical terminals for use in establishing the communication channel with the specified one of the plurality of optical terminals. To implement the TDMA architecture for the optical system, the master controller may be configured, for each of a plurality of time slots, to prompt the beam director to position the dynamic optical switch at a specified angle corresponding to a specified one of the plurality of optical terminals, provide a specific data package for the specified one of the plurality of optical terminals to the optical transmitter, and receive data from the optical receiver based on the incoming optical signals received from the specified one of the plurality of optical terminals. The beam director may include a mechanical gimbal, an electronic beam steering mechanism, or a semi-mechanical beam steering mechanism.

In a third embodiment, a method may include, for each of a plurality of time slots in a TDMA optical system, positioning a dynamic optical switch at a specified angle corresponding to a location of a specified one of a plurality of optical terminals. The method may also include, for each of the plurality of time slots, transmitting outgoing optical signals from the dynamic optical switch to the specified one of the plurality of optical terminals. The method may further include, for each of the plurality of time slots, receiving incoming optical signals at the dynamic optical switch from the specified one of the plurality of optical terminals.

Any single one or any combination of the following features may be used with the third embodiment. The method may include monitoring and tracking locations for each of the plurality of optical terminals for use in positioning the dynamic optical switch, optimizing bandwidth for the optical system by providing load balancing for the plurality of optical terminals, and assigning the plurality of time slots to the plurality of optical terminals based on the optimized bandwidth. The method may include receiving the outgoing optical signals transmitted from the dynamic optical switch at one or more modulating retroreflectors of the specified one of the optical terminals, generating the incoming optical signals at the one or more modulating retroreflectors by encoding data onto the outgoing optical signals received from the dynamic optical switch, and reflecting the incoming optical signals from the one or more modulating retroreflectors toward the dynamic optical switch. The method may include receiving the outgoing optical signals transmitted from the dynamic optical switch at a second dynamic optical switch of the specified one of the optical terminals, generating the incoming optical signals at the specified one of the optical terminals, and transmitting the incoming optical signals from the specified one of the optical terminals toward the dynamic optical switch.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1A illustrates an example of an optical system supporting multipoint access according to this disclosure;

FIG. 1B illustrates another example of an optical system supporting multipoint access according to this disclosure;

FIG. 2 illustrates yet another example of an optical system supporting multipoint access according to this disclosure;

FIG. 3 illustrates still another example of an optical system supporting multipoint access according to this disclosure;

FIG. 4 illustrates a graph depicting examples of bandwidth capacity for an optical system supporting multipoint access according to this disclosure; and

FIG. 5 illustrates an example of a method for providing multipoint access using an optical system according to this disclosure.

### DETAILED DESCRIPTION

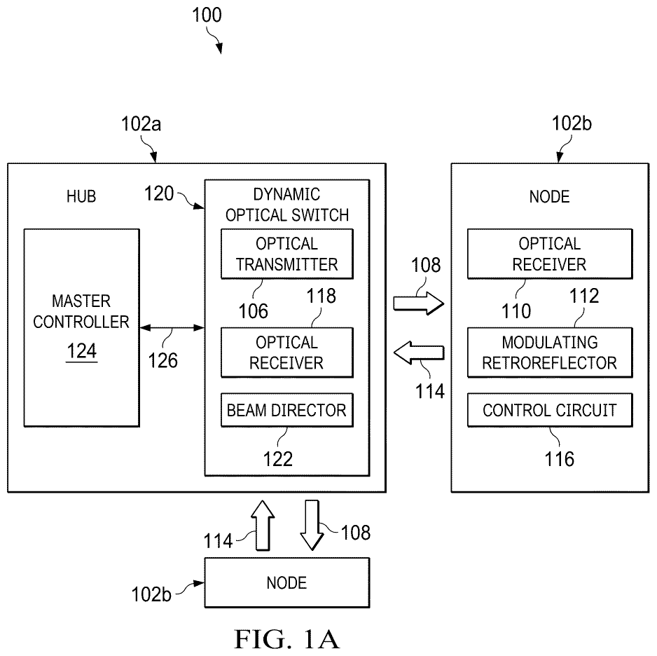

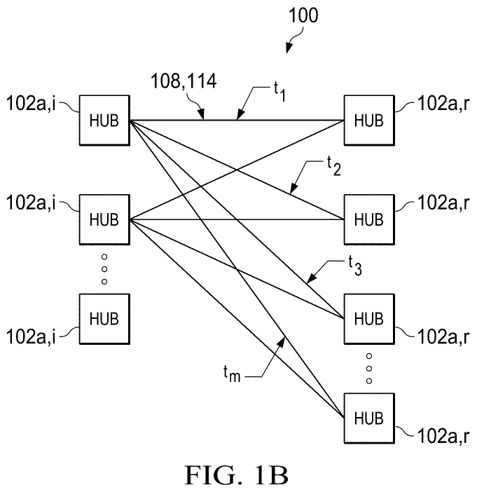

FIGS. 1A through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, a free-space optical communication (FSOC) system is generally a point-to-point communications link between two optical terminals that can transmit light to and/or receive light from each other through free space rather than through fiber optic cables or other physical cables. By using high directivity and narrow beams, an FSOC system can provide low power, high bandwidth communication. However, these benefits of optical communication are limited when servicing multiple user nodes (such as in a mesh network). Attempting to scale FSOC systems in a way that is similar to fiber-optic networks, such as using a passive optical network (PON) architecture, is costly since each connection requires its own dedicated FSOC optical terminal with relatively high size, weight, and power requirements. Likewise, implementing a mesh network similar to an optical inter-satellite link (OISL) network also requires multiple optical terminals to provide multi-user connectivity, where each terminal only connects to one other terminal.

This disclosure provides various free-space optical communication systems. As described in more detail below, each of the optical systems can include a hub having a dynamic optical switch and a master controller. The dynamic optical switch can include an optical transmitter, an optical receiver, and a beam director. The optical transmitter can be configured to transmit outgoing optical signals to a plurality of optical terminals. The optical receiver can be configured to receive incoming optical signals from the plurality of optical terminals. The beam director can be configured to position the dynamic optical switch at a plurality of angles. The master controller can be configured to provide multipoint access for the optical system by implementing a time division multiple access (TDMA) architecture for the optical system.

In this way, the described techniques can provide the ability to service multiple optical terminals using a single FSOC terminal to create a network architecture that enables higher capacity and more robust networking topologies. For example, instead of using a pointing, acquisition and tracking (PAT) system for a single point acquisition, the PAT system can be used as a dynamic optical switch, allowing movement of a beam between various optical terminals. This allows for the creation of a local area network of different optical terminals (that can be dynamically moving around) with a single PAT system providing communication with the multiple optical terminals using time division multiplexing. Thus, data for an optical system can be distributed via a TDMA protocol to transmit and/or receive data specific to each optical terminal. This allows the establishment of an ad-hoc network that is dynamic and that can switch to any one of the optical terminals within the optical system. As a result, dynamic addressing, load balancing, and the like can be enabled, and the implementation of TDMA allows for sustained high bandwidth communication across the optical system using the ultra-high speed of laser communication capacity.

FIG. 1A illustrates an example of an optical system 100 supporting multipoint access according to this disclosure. The embodiment of the optical system 100 shown in FIG. 1A is for illustration only. Other embodiments of the optical system 100 may be used without departing from the scope of this disclosure.

According to embodiments of this disclosure, the optical system 100 includes multiple spatially-separated optical terminals 102 that include at least one hub 102a and two or more other optical terminals 102, such as nodes 102b. In the embodiment illustrated in FIG. 1A, the optical system 100 represents a ground-, air-, or space-based system that can provide optical communication or other optical interaction between the hub 102a and the nodes 102b. In this example, the hub 102a includes an optical transmitter 106, which generally operates to produce outgoing optical signals 108 used for communication or other purposes. For example, the optical transmitter 106 may represent a laser or other optical source that can generate the outgoing optical signals 108 for transmission toward one of the nodes 102b.

Each node 102b can include an optical receiver 110 and a modulating retroreflector 112. The optical receiver 110 receives and decodes the outgoing optical signals 108 in order to recover data from the outgoing optical signals 108. Any suitable type(s) of modulation/demodulation scheme or schemes may be used here to encode and decode the outgoing optical signals 108. In some cases, the optical receiver 110 may represent an etalon-based receiver, which can allow for end-to-end low size, weight, power, and cost (SWAP-C) free-space communications. Example embodiments of etalon-based receivers that may be used here are described in U.S. Pat. No. 10,177,856 and U.S. Pat. No. 9,973,281 (both of which are hereby incorporated by reference in their entirety).

The modulating retroreflector 112 also receives the outgoing optical signals 108 from the hub 102a and reflects the outgoing optical signals 108 back toward the hub 102a as incoming optical signals 114. The node 102b can also include a control circuit 116. In some embodiments, the control circuit 116 can include a photodetector, which can be configured to detect the outgoing optical signals 108. In some other embodiments, the node 102b can include a photodetector as a separate component from the control circuit 116. Based on the detection of the outgoing optical signals 108 by the photodetector, the control circuit 116 can signal the modulating retroreflector 112 to modulate the light received in the outgoing optical signals 108 before reflecting the modulated light as the incoming optical signals 114. Thus, based on a signal provided by the control circuit 116, the modulating retroreflector 112 can be configured to provide phase, intensity, or other modulations to the outgoing optical signals 108 in order to encode data onto the incoming optical signals 114 reflected from the modulating retroreflector 112.

The data encoded onto the incoming optical signals 114 may include identification information identifying the node 102b and/or data collected or otherwise obtained by the node 102b. Note, however, that the modulating retroreflector 112 may encode any other or additional data onto the incoming optical signals 114. The use of modulating retroreflectors 112 in the nodes 102b can allow for the establishment of a communication channel between the hub 102a and each of the nodes 102b relatively quickly as there is no need for a handshake routine before communication can begin because the communication link is self-aligned. Thus, this ability to omit a handshake routine can increase the overall bandwidth of the optical system 100.

The hub 102a further includes an optical receiver 118 that receives the incoming optical signals 114 and decodes the modulations contained in the incoming optical signals 114 in order to recover the data from the incoming optical signals 114. Any suitable type(s) of modulation/demodulation scheme or schemes may be used here to encode and decode the incoming optical signals 114. In some cases, the optical receiver 118 may represent an etalon-based receiver, as described above in connection with the optical receiver 110. In addition, in some cases, the optical transmitter 106 and the optical receiver 118 can be integrated into a single optical transceiver that is configured to function as both an optical transmitter and an optical receiver.

A dynamic optical switch 120 for the optical system 100 can include the optical transmitter 106, the optical receiver 118, and a beam director 122. The beam director 122 can be configured to position the dynamic optical switch 120 at multiple different angles such that the dynamic optical switch 120 can be pointed toward any one of the multiple nodes 102b. The beam director 122 can include any general coarse beam directing apparatus, such as a mechanical, non-mechanical, or semi-mechanical beam steering mechanism, body-steering, or the like. Thus, in some cases, the beam director 122 can include a multi-degree of freedom opto-mechanical assembly configured to mechanically redirect the position of the dynamic optical switch 120. In other cases, the beam director 122 can include a non-mechanical electrically-steered assembly configured to electrically redirect the position of the dynamic optical switch 120. In still other cases, the beam director 122 can include Risley prisms, electrically-switchable planar gratings, or the like for positioning the dynamic optical switch 120. In particular examples, the beam director 122 can include a mechanical gimbal, a steering mechanism configured to reposition one or more fast steering mirrors, electronic beam steering technologies for optical communications and lidar sensors, such as optical phased array (OPA) technologies (for example, by TAARA CONNECT, INC., or ANALOG PHOTONICS), other electronic beam steering technologies, such as BEAM CO.'s planar optics technologies using liquid crystals, or other suitable beam steering technology configurable to enable high-speed, agile beam steering capabilities.

The hub 102a can also include a master controller 124 that is communicatively coupled to the dynamic optical switch 120 through a control signal 126. The master controller 124 can be configured to generate the outgoing optical signals 108 and to process the incoming optical signals 114. As described in more detail below, the master controller 124 can be configured to provide multipoint access for the optical system 100 by assigning time slots to each of the multiple nodes 102b and switching the hub 102a to communicate with each one of the multiple nodes 102b based on the assigned time slots. For example, the master controller 124 can be configured to implement a TDMA architecture for the optical system 100 such that communication is provided between the hub 102a and each of the nodes 102b based on time division multiplexing. In some cases, the master controller 124 can be configured to provide active switching by determining to which node 102b a specific data package should be sent and directing the beam director 122 to position the dynamic optical switch 120 to point toward that node 102b for delivery of the specific data package through optical communication.

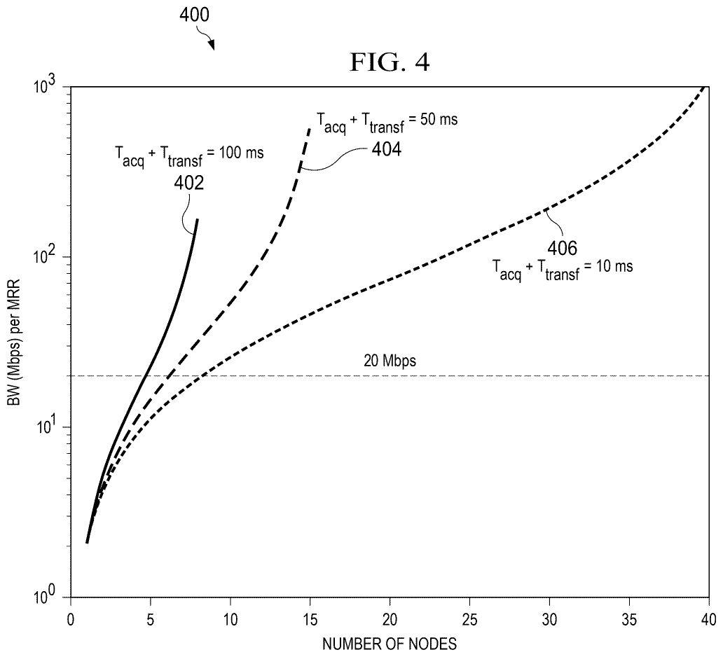

In some embodiments, the hub 102a can include a PAT system that can be implemented through the dynamic optical switch 120 and the master controller 124. In particular embodiments, the hub 102a can establish communication with each of the nodes 102b at a range of up to about 12 to 20 km. However, the hub 102a can provide communication at any other suitable range. In some embodiments, the optical transmitter 106 can include a gimballed laser. In particular embodiments, the optical transmitter 106 can include a 1 W laser transmitter. However, any other suitable optical transmitter can be used for the optical transmitter 106. As described in more detail below in connection with FIG. 4, in some cases, the hub 102a can provide a bandwidth capacity of about 10 Mbps up to about 10 Gbps or more. Note that the hub 102a can provide any suitable bandwidth depending on the number of nodes 102b and other factors, such as the communication rates of the modulating retroreflectors 112. In some embodiments, each modulating retroreflector 112 can provide communication at a rate of about 5 Mbps or other suitable rate.

Using the modulating retroreflectors 112 in the nodes 102b for auto-link establishment eliminates the need for two-way link connectivity and handshaking. Thus, use of the modulating retroreflectors 112 can result in fast acquisition times for the hub 102a, which allows the hub 102a to service more user nodes 102b through the dynamic optical switch 120 than would otherwise be possible. In this way, the optical system 100 can provide free-space optical communication that is able to achieve and sustain a high network bandwidth. In addition, the use of TDMA allows the hub 102a to load balance data capacity and distribution to individual user nodes 102b during assigned time slots for each of the nodes 102b. Dynamic addressing provided by the dynamic optical switch 120 through the use of TDMA also provides flexibility to trade bandwidth based on the number of nodes 102b being serviced by the hub 102a.

FIG. 1B illustrates another example of the optical system 100 supporting multipoint access according to this disclosure. In this embodiment, the multiple optical terminals 102 include at least three hubs 102a. Each of the hubs 102a can be configured to function as the hub 102a of FIG. 1A; however, for this embodiment, each hub 102a can communicate with other hubs 102a instead of nodes 102b to form a meshed network. As illustrated in FIG. 1B, the optical system 100 can include one or more initiating hubs 102a,i, each configured to function as the hub 102a of FIG. 1A and, thus, configured to initiate communication with other hubs 102a, while responding hubs 102a,r can be configured to respond to the communication initiated by the initiating hubs 102a,i. Thus, the optical system 100 can include any suitable combination of at least one initiating hub 102a,i and at least two responding hubs 102a,r.

In the illustrated embodiment, the optical system 100 includes an N×M mesh network, with N initiating hubs 102a,i configured to communicate with another M responding hubs 102a,r. For this embodiment, the master controller 124 for each initiating hub 102a,i can be configured to provide a TDMA architecture by prompting the beam director 122 to position the dynamic optical switch 120 such that the dynamic optical switch 120 points toward a specified responding hub 102a,r during a time slot assigned to the specified responding hub 102a,r. As illustrated in FIG. 1B, the master controller 124 for a first one of the initiating hubs 102a,i can control the dynamic optical switch 120 to point toward a first one of the responding hubs 102a,r to provide communication between the first of the initiating hubs 102a,i and the first of the responding hubs 102a,r during a time slot t₁. Similarly, the beam director 122 can move the dynamic optical switch 120 to point toward additional ones of the responding hubs 102a,r to provide communication for a second of the responding hubs 102a,r during a time slot t₂, and so on.

The optical systems 100 illustrated in FIGS. 1A and 1B may find use in a large number of applications. For example, the optical system 100 may be used to support optical communications in various terrestrial and space-based applications, including applications that involve overt and/or covert data transfers. As particular examples, the optical system 100 may be used to support backhaul optical communications in 5G networks or other telecommunications networks or to support ship-to-shore or other ship-based communications. As other particular examples, optical system 100 may be used to support optical communications for data exfiltration from disadvantaged platforms like micro-satellites and unmanned aerial vehicles (UAVs). As yet another particular example, the optical system 100 may be used to support point-to-point optical communications for various purposes. Note, however, that this disclosure is not limited to any particular application of the optical system 100.

Although FIGS. 1A and 1B illustrate examples of an optical system 100 supporting multipoint access, various changes may be made to FIGS. 1A and 1B. For example, while only two nodes 102b are shown in FIG. 1A, the optical system 100 may include any suitable number of nodes 102b that can engage in any suitable optical communications or other optical interactions with the hub 102a. Also, while three initiating hubs 102a,i and four responding hubs 102a,r are shown in FIG. 1B, the optical system 100 may include any suitable number of hubs 102a that can engage in any suitable optical communications or other optical interactions with other hubs 102a. In addition, in some cases, a hub 102a can be configured to communicate with one or more nodes 102b, as well as one or more other hubs 102a. In some embodiments, a hub 102a can also include a modulating retroreflector 112 and can communicate with another hub 102a in a similar way to the nodes 102b. Furthermore, the modulating retroreflector 112 of the nodes 102b can represent an array of modulating retroreflectors 112. In these embodiments, a single control circuit 116 can be provided for the array, a control circuit 116 can be provided for each modulating retroreflector 112, or any suitable combination of control circuits 116 and modulating retroreflectors 112 can be implemented. Further, the optical system 100 is shown in simplified form here and may include any number of additional components in any suitable configuration as needed or desired. In addition, the views shown in FIGS. 1A and 1B are not to scale.

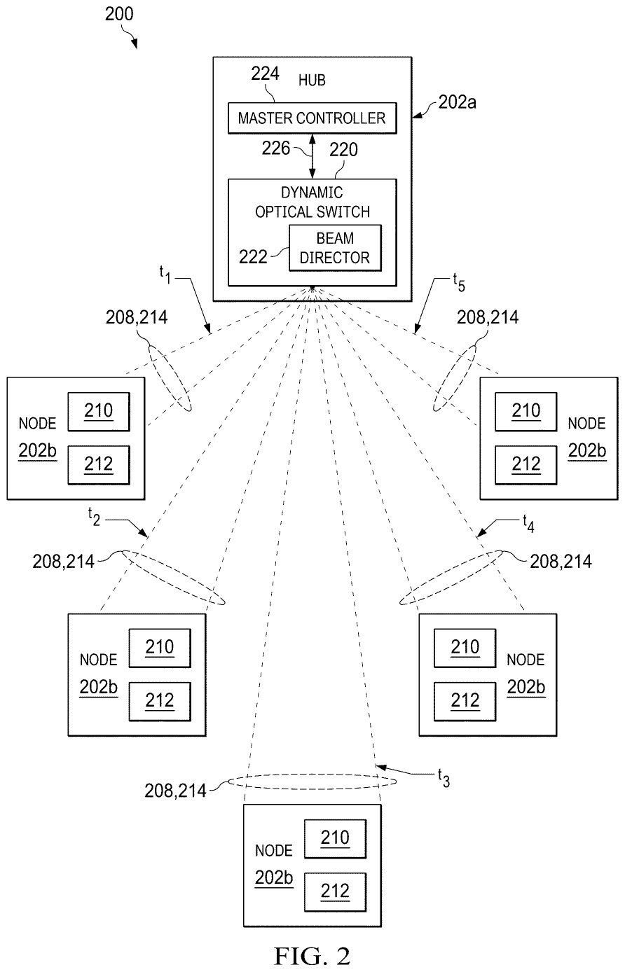

FIG. 2 illustrates yet another example of an optical system 200 supporting multipoint access according to this disclosure. The embodiment of the optical system 200 shown in FIG. 2 is for illustration only. Other embodiments of the optical system 200 may be used without departing from the scope of this disclosure.

According to embodiments of this disclosure, the optical system 200 can include multiple optical terminals 202 that include a hub 202a and two or more nodes 202b. The hub 202a can include a dynamic optical switch 220, which can include a beam director 222, and a master controller 224, and each node 202b can include an optical receiver 210 and a modulating retroreflector array 212. The hub 202a may represent a possible implementation of the hub 102a of FIG. 1A. Also, each of the nodes 202b may represent a possible implementation of one of the nodes 102b of FIG. 1A. Thus, the hub 202a can be configured to transmit outgoing optical signals 208 to the nodes 202b and to receive incoming optical signals 214 reflected back from the nodes 202b. Further, the dynamic optical switch 220, the beam director 222, and the master controller 224 can represent possible implementations of the dynamic optical switch 120, the beam director 122, and the master controller 124 of FIG. 1A, respectively. Likewise, the optical receiver 210 and the modulating retroreflector arrays 212 can represent possible implementations of the optical receiver 110 and the modulating retroreflector 112 of FIG. 1A, respectively.

The master controller 224 can be configured to provide a TDMA architecture for the optical system 200. Thus, the master controller 224 can be configured to prompt the beam director 222, through a control signal 226, to position the dynamic optical switch 220 such that the dynamic optical switch 220 points toward a specified node 202b during a time slot assigned to the specified node 202b. As illustrated in FIG. 2, the master controller 224 can control the dynamic optical switch 220, through the control signal 226 provided to the beam director 222, to point toward a first node 202b to provide communication between the hub 102a and the first node 202b during a time slot t₁. Similarly, the beam director 222 can move the dynamic optical switch 220 to point toward additional nodes 202b to provide communication for a second node 202b during a time slot t₂, a third node 202b during a time slot t₃, a fourth node 202b during a time slot t₄, and a fifth node 202b during a time slot t₅. In some embodiments, the master controller 224 can be configured to cycle between the nodes 202b in sequential order. Thus, for the illustrated embodiment, communication can be provided for the first node 202b again during a time slot t₆, etc. In these embodiments, each time slot may be a same amount of time, or the master controller 224 can be configured to provide communication with each node 202b for any suitable amount of time based on any suitable parameters.

In other embodiments, the master controller 224 can be configured to communicate with the nodes 202b in any suitable order, not simply sequentially. Thus, in these embodiments, the hub 202a can communicate with the nodes 202b in any suitable order, including repeating communication with any node 202b before providing communication with remaining nodes 202b, and the order of communication may change at any time based on any suitable parameters. In addition, the master controller 224 can provide communication between the hub 202a and any one of the nodes 202b for any suitable amount of time during any particular time slot of communication. Thus, for each time slot of communication for each node 202b, the amount of time included in the time slot may be a same or different amount of time as compared to other time slots of communication with the same or other nodes 202b.

The master controller 224 can also be configured to monitor and track locations for each of the nodes 202b and to optimize bandwidth by providing load balancing or other optimization measures. Thus, the master controller 224 can be configured to determine individually for each node 202b the type of data to be sent, how much data is to be sent, the priority for the data to be sent as compared to data for other nodes 202b, and the like. Based on these types of considerations, the master controller 224 can be configured to determine time slot assignments for the nodes 202b, including lengths of each of the time slots and an order for the time slot assignments.

The master controller 224 can also be configured, based on the determined time slot assignments, to direct the dynamic optical switch 220 to point toward a specified node 202b during an assigned time slot and to transmit outgoing optical signals 208, which can include a specific data package for the specified node 202b, during at least a portion of the assigned time slot. In addition, the master controller 224 can be configured to quickly re-acquire communication with each of the nodes 202b when switching between nodes 202b based on the monitoring and tracking of node locations. For each time slot, the master controller 224 can be configured to deliver a specific data package to and/or receive incoming optical signals 214 reflected from a specified node 202b at a position monitored and tracked by the master controller 224. In addition, in some embodiments, the master controller 224 can be configured to deliver a same data payload individually to each one of the nodes 202b for a 1:N broadcasting mode.

Although FIG. 2 illustrates another example of an optical system 200 supporting multipoint access, various changes may be made to FIG. 2. For example, while five nodes 202b are shown here, the optical system 200 may include any suitable number of nodes 202b. Also, in some embodiments, a single modulating retroreflector can be used instead of the modulating retroreflector array 212. Further, the optical system 200 is shown in simplified form here and may include any number of additional components in any suitable configuration as needed or desired, including photodetectors and control circuits in the nodes 202b. In addition, the view shown in FIG. 2 is not to scale.

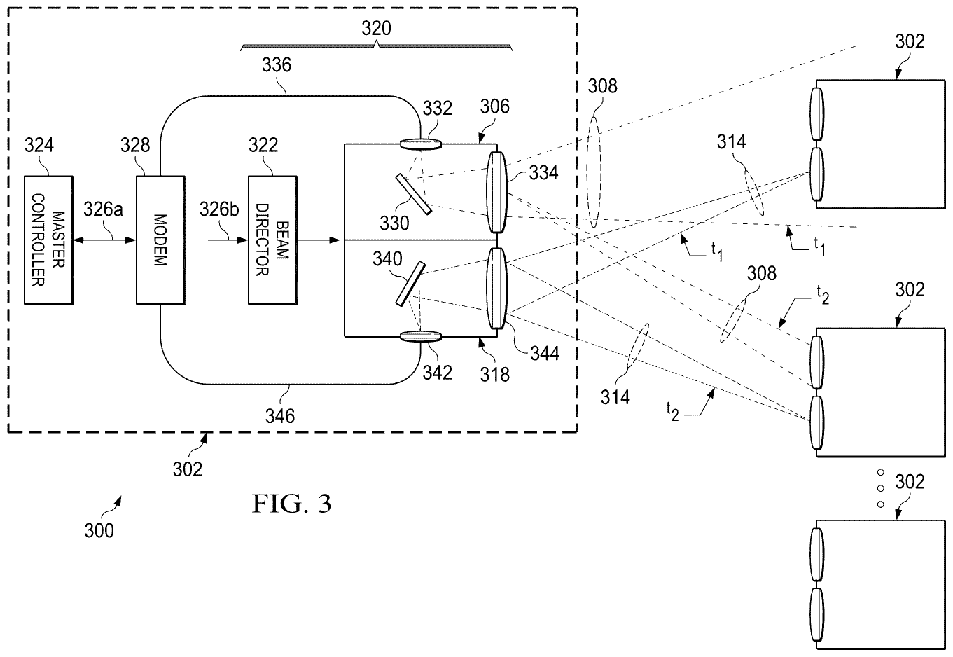

FIG. 3 illustrates still another example of an optical system 300 supporting multipoint access according to this disclosure. The embodiment of the optical system 300 shown in FIG. 3 is for illustration only. Other embodiments of the optical system 300 may be used without departing from the scope of this disclosure.

According to embodiments of this disclosure, the optical system 300 can include multiple optical terminals 302 that include three or more hubs 302. Each hub 302 can include a dynamic optical switch 320, a beam director 322, and a master controller 324. Each hub 302 may represent a possible implementation of the hub 102a of FIG. 1A or 1B. Each hub 302 can be configured to transmit outgoing optical signals 308 to the other hubs 302 and to receive incoming optical signals 314 transmitted by the other hubs 302. Further, the dynamic optical switch 320, the beam director 322, and the master controller 324 can represent possible implementations of the dynamic optical switch 120, the beam director 122, and the master controller 124 of FIG. 1A, respectively, and/or the dynamic optical switch 220, the beam director 222, and the master controller 224 of FIG. 2, respectively. Thus, the master controller 324 can be configured to provide a TDMA architecture for the optical system 300, monitoring and tracking hub locations, optimizing bandwidth, and assigning time slots to the hubs 302 similar to the master controllers 124 and 224 of FIGS. 1A and 2 with regard to the nodes 102b and 202b.

As illustrated in FIG. 3, each hub 302 can also include a modem 328, and the beam director 322 and the modem 328 can each be coupled to the master controller 324. In the illustrated embodiment, the control signal 326 can include a data signal 326a and a switch signal 326b. The modem 328 can be configured to convert a digital data signal 326a from the master controller 324 into optical signals to be transmitted from the dynamic optical switch 320 as the outgoing optical signals 308 and can be configured to convert the incoming optical signals 314 received at the dynamic optical switch 320 from optical signals into a digital data signal 326a for the master controller 324. Based on the switch signal 326b, the beam director 322 can be configured to position the dynamic optical switch 320 at multiple different angles such that the dynamic optical switch 320 can be pointed toward any one of the other hubs 302.

As with the dynamic optical switch 120, the dynamic optical switch 320 can include an optical transmitter 306 and an optical receiver 318, each of which can be coupled to the beam director 322. The optical transmitter 306 can include a fast-steering transmit mirror 330 and an optical telescope including a fiber-facing lens assembly 332 and an outward-facing lens assembly 334. The modem 328 can be coupled to the fiber-facing lens assembly 332 with a transmit fiber 336 and can be configured to provide the outgoing optical signal 308 for transmission to the optical transmitter 306 through the transmit fiber 336. The outgoing optical signal 308 can be directed by the fiber-facing lens assembly 332 toward the fast-steering transmit mirror 330, which can direct the outgoing optical signal 308 toward the outward-facing lens assembly 334, which can transmit the outgoing optical signal 308 out from the hub 302.

Similarly, the optical receiver 318 can include a fast-steering receive mirror 340 and an optical telescope including a fiber-facing lens assembly 342 and an outward-facing lens assembly 344. The modem 328 can be coupled to the fiber-facing lens assembly 342 with a receive fiber 346. The incoming optical signal 314 can be received at the hub 302 through the outward-facing lens assembly 344, which can direct the incoming optical signal 314 toward the fast-steering receive mirror 340. The fast-steering receive mirror 340 can direct the incoming optical signal 314 toward the fiber-facing lens assembly 342, which can provide the incoming optical signal 314 to the modem 328 through the receive fiber 346. The modem 328 can be configured to receive the incoming optical signal 314 through the receive fiber 346 and to convert the incoming optical signal 314 into a digital signal and provide the digital signal to the master controller 324 for processing through the data signal 326a. In some embodiments, the beam director 322 can provide coarse beam steering, while the fast-steering mirrors 330 and 340 can provide fine beam steering. This can provide a larger field of regard than the use of fast-steering mirrors 330 and 340 without the beam director 322 would allow.

In operation, based on a specified hub 302 assigned to a current time slot for communication with an initiating hub 302, the master controller 324 of the initiating hub 302 can generate a data signal 326a to provide a specific data package for the specified hub 302 to the modem 328 and a switch signal 326b to prompt the beam director 322 to position the dynamic optical switch 320 to be able to send data to and/or receive data from the specified hub 302. In addition, the modem 328 can generate a data signal 326a to provide data received from the specified hub 302 to the master controller 324. Thus, the data signal 326a can include data sent to the modem 328 by the master controller 324 that the modem 328 can convert into the outgoing optical signal 308 and provide to the optical transmitter 306 through the transmit fiber 336. Likewise, the data signal 326a can include data received at the modem 328 through the receive fiber 346 and converted by the modem 328 from the incoming optical signal 314 into a digital signal for processing by the master controller 324. The switch signal 326b can prompt the beam director 322 to mechanically and/or electrically position the fast-steering mirrors 330 and 340 such that the outgoing optical signals 308 and 314 are aligned for the dynamic optical switch 320 and the specified hub 302.

Although FIG. 3 illustrates another example of an optical system 300 supporting multipoint access, various changes may be made to FIG. 3. For example, while four hubs 302 are explicitly shown here, the optical system 300 may include any suitable number of hubs 302. In addition, while the dynamic optical switch 320 is shown with a separate optical transmitter 306 and optical receiver 318, the dynamic optical switch 320 can instead include an integrated transceiver configured to both transmit and receive optical signals 308, 314. In these embodiments, the dynamic optical switch 320 can include a single fast-steering mirror and a single optical telescope that together can function as both an optical transmitter 306 and an optical receiver 318. Thus, the single fast-steering mirror can be used with the other optical components to substantially simultaneously direct outgoing optical signals 308 to a specified hub 302 and to receive incoming optical signals 314 from the specified hub 302. Further, the dynamic optical switch 320 can include an electrically-steerable non-mechanical transceiver employing an OPA, electrically-controlled liquid crystal grating-based planar optics, a semi-mechanical transceiver, such as a Risley-prism-based system, or any combination of such technologies. Also, the optical system 300 is shown in simplified form here and may include any number of additional components in any suitable configuration as needed or desired. In addition, the view shown in FIG. 3 is not to scale.

FIG. 4 illustrates a graph 400 depicting examples of bandwidth capacity for an optical system 100, 200 supporting multipoint access according to this disclosure. The graph illustrates bandwidth trade-offs relative to a number of nodes 102b, 202b in the optical system 100, 200. The kinematics and stabilization time of a PAT system provided by the master controller 124, 224 of the hub 102a, 202a can drive the bandwidth capacity for the optical system 100, 200 and can determine a number of nodes 102b, 202b that can be included in the optical system 100, 200 for a particular bandwidth. Using modulating retroreflectors 112 or modulating retroreflector arrays 212 in the nodes 102b, 202b can enable faster connection speeds for the hub 102a, 202a due to self-alignment and the lack of a need for point-to-point handshaking in establishing a communication channel.

As shown in the graph 400, in some embodiments, the bandwidth for each modulating retroreflector 112 (or for each modulating retroreflector in the modulating retroreflector arrays 212) can depend on the number of nodes 102b, 202b in communication with the hub 102a, 202a, in addition to the amount of time allocated for each time slot. Each time slot can include an amount of time used for acquisition of the communication channel with a node 102b, 202b (T_{acq}) added to the amount of time available for transferring data to and/or from the node 102b, 202b (T_{transf}). By using the modulating retroreflectors 112 or modulating retroreflector arrays 212, the acquisition time can be minimized, which allows more time for data transfer and/or quicker switching between nodes 102b, 202b.

In the example illustrated in the graph 400, the bandwidth for each modulating retroreflector 112 (or for each modulating retroreflector in the modulating retroreflector arrays 212) based on the total number of nodes 102b, 202b in communication with the hub 102a, 202a is shown for some possible time slot lengths (T_{acq}+T_{transf}). The curve 402 corresponds to a time slot length of about 100 ms, the curve 404 corresponds to a time slot length of about 50 ms, and the curve 406 corresponds to a time slot length of about 10 ms. Thus, for modulating retroreflectors 112 or modulating retroreflector arrays 212 that can support a bandwidth of about 20 Mbps, a time slot length of about 100 ms can allow communication between the hub 102a, 202a and about five nodes 102b, 202b. Similarly, a time slot length of about 50 ms can allow communication between the hub 102a, 202a and about six nodes 102b, 202b, and a time slot length of about 10 ms can allow communication between the hub 102a, 202a and about eight nodes 102b, 202b. Increasing the bandwidth for the modulating retroreflectors 112 or modulating retroreflector arrays 212 can allow the optical system 100 to provide communication with a greater number of nodes 102b, 202b and/or to increase the overall network bandwidth capacity.

Although FIG. 4 illustrates one example of graph 400 depicting examples of bandwidth capacity for an optical system 100, 200 supporting multipoint access, various changes may be made to FIG. 4. For example, the specific curves shown in FIG. 4 are for illustration only and can vary based on a number of factors.

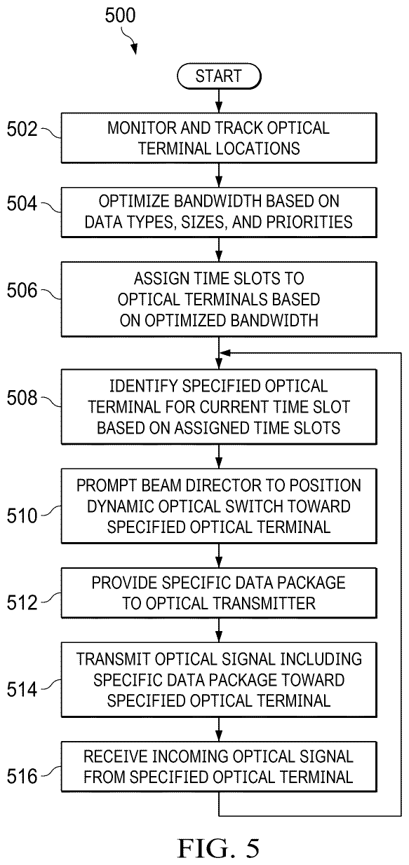

FIG. 5 illustrates an example of a method 500 for providing multipoint access using an optical system 100, 200, 300 according to this disclosure. As shown in FIG. 5, a hub 102a, 202a, 302 monitors and tracks locations of optical terminals 102b, 202b, 302 in the optical system 100, 200, 300 at step 502. This may include, for example, a master controller 124, 224, 324 of the hub 102a, 202a, 302 operating a platform tracking system that can keep track of optical terminal locations to assist in acquiring any one of the nodes 102b, 202b or hubs 302 as the hub 102a, 202a, 302 quickly switches communication between multiple nodes 102b, 202b or hubs 302.

The master controller 124, 224, 324 optimizes the network bandwidth capacity for the optical system 100 based on data types, sizes, and priorities at step 504. This may include, for example, the master controller 124, 224, 324 providing load balancing or other optimization measures for the optical system 100. In some embodiments, the master controller 124, 224, 324 can determine individually for each node 102b, 202b or hub 302 the type of data to be sent, how much data is to be sent, a priority for the data to be sent, and the like, and can optimize bandwidth based on at least these factors.

The master controller 124, 224, 324 assigns time slots to optical terminals 102b, 202b, 302 based on the optimized bandwidth at step 506. This may include, for example, the master controller 124, 224, 324 determining lengths of each of the time slots and an order for the time slot assignments based on the optimization of the bandwidth in accordance with the data types, sizes and priorities. The master controller 124, 224, 324 identifies a specified optical terminal 102b, 202b, 302 for a current time slot based on the assigned time slots at step 508. This may include, for example, the master controller 124, 224, 324 identifying a particular one of the nodes 102b, 202b or hubs 302 that has been assigned to a current time slot for communication.

The master controller 124, 224, 324 prompts a beam director 122, 222, 322 to position a dynamic optical switch 120, 220, 320 toward the specified optical terminal 102b, 202b, 302 at step 510. This may include, for example, the master controller 124, 224, 324 generating a control signal 126, 226 or switch signal 326b to prompt the beam director 122, 222, 322 to mechanically and/or electrically move the dynamic optical switch 120, 220, 320 to an angle corresponding to the monitored and tracked location of the specified node 102b, 202b or hub 302. In some cases, the master controller 124, 224, 324 can prompt the beam director 122, 222, 322 to reposition a fast-steering transmit mirror 330 and a fast-steering receive mirror 340 (or to reposition a single fast-steering mirror) for the dynamic optical switch 120, 220, 320 based on the angle corresponding to the optical terminal location.

The master controller 124, 224, 324 provides a specific data package to an optical transmitter 106, 306 of the dynamic optical switch 120, 220, 320 at step 512. This may include, for example, the master controller 124, 224, 324 sending the specific data package to a modem 328 of the hub 102a, 202a, 302 through the control signal 126, 226 or a data signal 326a, the modem 328 converting the specific data package into an optical signal, and the modem 328 providing the optical signal to the optical transmitter 106, 306. The hub 102a, 202a, 302 transmits an outgoing optical signal 108, 208, 308 including the specific data package toward the specified optical terminal 102b, 202b, 302 at step 514. This may include, for example, the optical transmitter 106, 306 transmitting the outgoing optical signal 108, 208, 308 toward the specified node 102b, 202b or hub 302.

The hub 102a, 202a, 302 receives an incoming optical signal 114, 214, 314 from the specified optical terminal 102b, 202b, 302 at step 516. This may include, for example, an optical receiver 118 of the dynamic optical switch 120, 220 receiving the incoming optical signal 114, 214 after reflection from a modulating retroreflector 112 or a modulating retroreflector array 212 of the specified node 102b, 202b. This may also include, for example, an optical receiver 318 of the dynamic optical switch 320 receiving the incoming optical signal 314 that has been transmitted by the specified hub 302. In some embodiments, the incoming optical signal 114, 214, 314 may be provided from the optical receiver 118, 318 to the modem 328, the modem 328 may convert the incoming optical signal 114, 214, 314 into digital data, and the modem 328 may provide the digital data to the master controller 124, 224, 324 through the control signal 126, 226 or data signal 326a for decoding. At this point, the method 500 may return to step 508, where the master controller 124, 224, 324 can continue to identify specified optical terminals 102b, 202b, 302 for the current time slot based on the assigned time slots.

In this way, auto-link establishment provided by using the modulating retroreflectors 112 or modulating retroreflector arrays 212 in the nodes 102b, 202b can eliminate the need for two-way link connectivity and handshaking. Thus, the modulating retroreflectors 112, or modulating retroreflector arrays 212 can allow fast acquisition times for the hub 102a, 202a, which allows the hub 102a, 202a to service multiple user nodes 102b, 202b through the dynamic optical switch 120, 220 and thereby provide free-space optical communication that can achieve and sustain a high network bandwidth. Similarly, using a high-speed beam director 322 can also allow fast acquisition times for a hub 302, allowing the hub 302 to service multiple other hubs 302 to provide a high-bandwidth meshed network. Also, the use of TDMA allows the hub 102a, 202a, 302 to load balance data capacity and distribution to individual optical terminals 102b, 202b, 302 during assigned time slots for each of the optical terminals 102b, 202b, 302. In addition, dynamic addressing with the dynamic optical switch 120, 220, 320 using TDMA provides flexibility to trade bandwidth with a number of optical terminals 102b, 202b, 302 being serviced by the hub 102a, 202a, 302.

Although FIG. 5 illustrates one example of a method 500 for providing multipoint access using an optical system, various changes may be made to FIG. 5. For example, while shown as a series of steps, various steps in FIG. 5 may overlap, occur in parallel, occur in a different order, or occur any number of times (including zero times). As a particular example, the master controller 124, 224, 324 can continue to monitor and track optical terminal locations at step 502, optimize bandwidth at step 504, and assign time slots at step 506 while other steps are being performed. Thus, the master controller 124, 224, 324 may be substantially continuously monitoring and tracking optical terminal locations and, at any suitable time, can re-optimize bandwidth and re-assign time slots based on updated bandwidth optimization.

In some embodiments, various functions described in this patent document are implemented or supported by a computer program or other program that is formed from computer readable program code or instructions and that is embodied in a computer or machine readable medium. The phrases “computer readable program code” and “instructions” include any type of code, including source code, object code, and executable code. The phrases “computer readable medium” and “machine readable medium” include any type of medium capable of being accessed by a computer or other machine, such as read only memory (ROM), random access memory (RAM), a hard disk drive (HDD), a compact disc (CD), a digital video disc (DVD), or any other type of memory. A “non-transitory” computer or machine readable medium excludes wired, wireless, optical, or other communication links that transport transitory electrical or other signals. A non-transitory computer or machine readable medium includes media where data can be permanently stored and media where data can be stored and later overwritten, such as a rewritable optical disc or an erasable storage device.

It may be advantageous to set forth definitions of certain words and phrases used throughout this patent document. The term “about” (when used with a numerical value) indicates that the numerical value may vary by up to ±10%. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A hub for an optical system comprising:
a dynamic optical switch comprising:
an optical transmitter configured to transmit outgoing optical signals to a plurality of optical terminals;
an optical receiver configured to receive incoming optical signals from the plurality of optical terminals; and
a beam director configured to position the dynamic optical switch at a plurality of angles; and
a master controller configured to provide multipoint access for the optical system by implementing a time division multiple access (TDMA) architecture for the optical system.

2. The hub of claim 1, wherein, to implement the TDMA architecture for the optical system, the master controller is configured to:
assign each of a plurality of time slots to a specified one of the plurality of optical terminals; and
for each of the plurality of time slots, direct the dynamic optical switch to establish a communication channel with the specified one of the plurality of optical terminals to which the time slot was assigned.

3. The hub of claim 2, wherein the master controller is further configured to monitor and track locations for each of the plurality of optical terminals for use in establishing the communication channel with the specified one of the plurality of optical terminals.

4. The hub of claim 1, wherein the master controller is further configured to generate the outgoing optical signals and to process the incoming optical signals.

5. The hub of claim 1, wherein:
the specified one of the plurality of optical terminals comprises at least one modulating retroreflector; and
the incoming optical signals comprise encoded optical signals reflected by the at least one modulating retroreflector.

6. The hub of claim 1, wherein the specified one of the plurality of optical terminals comprises:
a second dynamic optical switch comprising a second optical transmitter and a second optical receiver, the second optical receiver configured to receive the outgoing optical signals; and
a second master controller configured to process the outgoing optical signals and to generate the incoming optical signals;
wherein the second optical transmitter is configured to transmit the incoming optical signals toward the optical receiver.

7. The hub of claim 1, wherein, to implement the TDMA architecture for the optical system, the master controller is configured, for each of a plurality of time slots, to:
prompt the beam director to position the dynamic optical switch at a specified angle corresponding to a specified one of the plurality of optical terminals;
provide a specific data package for the specified one of the plurality of optical terminals to the optical transmitter; and
receive data from the optical receiver based on the incoming optical signals received from the specified one of the plurality of optical terminals.

8. The hub of claim 1, wherein the beam director comprises a mechanical gimbal, an electronic beam steering mechanism, or a semi-mechanical beam steering mechanism.

9. The hub of claim 1, wherein:
the dynamic optical switch further comprises at least one fast-steering mirror; and
the beam director is configured to position the dynamic optical switch at the plurality of angles by changing a position of the at least one fast-steering mirror.

10. An optical system comprising:
a hub; and
a plurality of optical terminals;
wherein the hub comprises:
a dynamic optical switch comprising:
an optical transmitter configured to transmit outgoing optical signals to the plurality of optical terminals;
an optical receiver configured to receive incoming optical signals from the plurality of optical terminals; and
a beam director configured to position the dynamic optical switch at a plurality of angles; and
a master controller configured to provide multipoint access for the optical system by implementing a time division multiple access (TDMA) architecture for the optical system; and
wherein each of the plurality of optical terminals is configured to:
receive the outgoing optical signals;
generate the incoming optical signals; and
provide the incoming optical signals to the hub.

11. The optical system of claim 10, wherein each of the plurality of optical terminals comprises at least one modulating retroreflector configured to:
receive the outgoing optical signals;
generate the incoming optical signals by encoding data onto the outgoing optical signals; and
provide the incoming optical signals to the hub by reflecting the incoming optical signals toward the optical receiver.

12. The optical system of claim 10, wherein each of the plurality of optical terminals comprises:
a second dynamic optical switch comprising a second optical transmitter and a second optical receiver, the second optical receiver configured to receive the outgoing optical signals; and
a second master controller configured to process the outgoing optical signals and to generate the incoming optical signals;
wherein the second optical transmitter is configured to provide the incoming optical signals to the hub by transmitting the incoming optical signals toward the optical receiver.

13. The optical system of claim 10, wherein, to implement the TDMA architecture for the optical system, the master controller is configured to:
assign each of a plurality of time slots to a specified one of the plurality of optical terminals; and
for each of the plurality of time slots, direct the dynamic optical switch to establish a communication channel with the specified one of the plurality of optical terminals to which the time slot was assigned.

14. The optical system of claim 13, wherein the master controller is further configured to monitor and track locations for each of the plurality of optical terminals for use in establishing the communication channel with the specified one of the plurality of optical terminals.

15. The optical system of claim 10, wherein, to implement the TDMA architecture for the optical system, the master controller is configured, for each of a plurality of time slots, to:
prompt the beam director to position the dynamic optical switch at a specified angle corresponding to a specified one of the plurality of optical terminals;
provide a specific data package for the specified one of the plurality of optical terminals to the optical transmitter; and
receive data from the optical receiver based on the incoming optical signals received from the specified one of the plurality of optical terminals.

16. The optical system of claim 10, wherein the beam director comprises a mechanical gimbal, an electronic beam steering mechanism, or a semi-mechanical beam steering mechanism.

17. A method comprising, for each of a plurality of time slots in a time division multiple access (TDMA) optical system:
positioning a dynamic optical switch at a specified angle corresponding to a location of a specified one of a plurality of optical terminals;
transmitting outgoing optical signals from the dynamic optical switch to the specified one of the plurality of optical terminals; and
receiving incoming optical signals at the dynamic optical switch from the specified one of the plurality of optical terminals.

18. The method of claim 17, further comprising:
monitoring and tracking locations for each of the plurality of optical terminals for use in positioning the dynamic optical switch;
optimizing bandwidth for the optical system by providing load balancing for the plurality of optical terminals; and
assigning the plurality of time slots to the plurality of optical terminals based on the optimized bandwidth.

19. The method of claim 17, further comprising:
receiving the outgoing optical signals transmitted from the dynamic optical switch at one or more modulating retroreflectors of the specified one of the optical terminals;
generating the incoming optical signals at the one or more modulating retroreflectors by encoding data onto the outgoing optical signals received from the dynamic optical switch; and
reflecting the incoming optical signals from the one or more modulating retroreflectors toward the dynamic optical switch.

20. The method of claim 17, further comprising:
receiving the outgoing optical signals transmitted from the dynamic optical switch at a second dynamic optical switch of the specified one of the optical terminals;
generating the incoming optical signals at the specified one of the optical terminals; and
transmitting the incoming optical signals from the specified one of the optical terminals toward the dynamic optical switch.
